(19) United States
(12) Patent Application Publication
(10) Pub. No.: US 2010/0084781 A1
(43) Pub. Date: Apr. 8, 2010

(54) Concrete Manufacturing Processes and Methods

(76) Inventors: Mei-In M. Chou, Urbana, IL (US); Roger A. Babb, Ringgold, GA (US); Sheng-Fu J. Chou, Urbana, IL (US)

Correspondence Address: WELLS ST. JOHN P.S., 601 W. FIRST AVENUE, SUITE 1300, SPOKANE, WA, 99201, US

(21) Appl. No.: 12/573,475

(22) Filed: Oct. 5, 2009

Related U.S. Application Data
(60) Provisional application No. 61/102,459, filed on Oct. 3, 2008.

(51) Int. Cl. C04B 18/06; C04B 14/04; B28B 11/14; B28C 5/00

(52) U.S. Cl. 264/157; 106/814; 106/705; 366/2

(57) ABSTRACT

Concrete manufacturing processes are provided that can include providing a plurality of substantially dry concrete raw materials to a mixing chamber, providing water to the mixing chamber, and mixing the water and raw materials to form a concrete raw material mixture. Concrete manufacturing processes can also include providing water, a silica source, a calcium source and an aluminum source to within a mixing chamber, with the calcium source being provided to within the chamber prior to the aluminum source. Concrete manufacturing processes can also include providing a combustion waste, a silica source, water and an aluminum source to form a concrete raw material mixture, processing the raw material mixture to form a concrete product. Concrete materials are provided that can include a combustion waste material, with the combustion waste material having at least 10% (wt./wt.) CaO.

### CROSS REFERENCE TO RELATED APPLICATION

This application claims priority under 35 U.S.C. §119 to U.S. Provisional Patent Application Ser. No. 61/102,459 entitled “Concrete Manufacturing Processes and Methods”, which was filed Oct. 3, 2008, the entirety of which is incorporated by reference herein

### BACKGROUND

Recently, construction materials are being utilized that include Autoclaved Aerated Concrete (AAC). These materials perform well in construction applications as they can provide both strength and insulative properties. However, the manufacture of these materials is not without challenges.

Regular AAC is made with a mix of ground sand, cement, and lime with a small amount of aluminum powder added to the mixed slurry. The aluminum powder functions like yeast in bread dough and produces porous AAC products with excellent heat and sound insulation properties. In accordance with example formulations, an amount of aluminum powder can be added to the mixed slurry to produce unconnected gas pockets in the AAC body which can generate final products having heat and sound insulation properties. In sand-based AAC plants, the feeds use about 60% (wt./wt.) ground sand. F-ash has been used to substitute sand in making AAC with the amount of 67% (wt./wt.) F-ash balanced with cement and lime. Additional sand and/or gypsum additives are also required to improve the working parameters and quality of the final AAC products.

Referring to FIG. 1, a schematic flow diagram representative of sand-based plant designed for the construction of concrete materials such as AAC is shown. According to example formulations the AAC may be made from a water slurry of ground sand, cement, and lime at about 60% (wt./wt.), 37% (wt./wt.), and 3% (wt./wt.), respectively. The sand must be ground in a ball mill and then suspended in a large slurry tank with constant agitation. A ball mill cost is in the range of $1 million. Ball mills use steel balls that must be replenished, have a high maintenance cost, and use a high horsepower (range of 500 to 1000) drive motor. A large slurry tank equipped with a mixer is required to slurry the ground sand. The cost of a slurry tank such as this can be as high as $250,000. Slurry tanks have a high maintenance cost and use a motor in the range of 50 to 100 horsepower. A slurry tank must be operated continuously and it can be a significant maintenance event if it is ever stopped.

Referring to FIG. 2, a schematic flow diagram representative of an F-ash-based AAC plant is shown. Class F fly ash (F-ash) has been used as a substitute for sand in making AAC in the amount of 67% (wt./wt.) F-ash balanced with 30% (wt./wt.) cement and 3% (wt./wt.) lime by weight. The ash can be blown into a silo from the delivery truck and then augured into two or three large slurry tanks with mixer to slurry the ash, where it must mix for at least 24 hours before moving into the main mixer. Two or more slurry tanks are required because it takes at least twelve hours to slurry the ash. Each slurry tank cost is in the range of $250,000. Each slurry tank has a high maintenance cost and uses a motor in the range of 50 to 100 horsepower. Each slurry tank must run constantly and it is a substantial maintenance event if one ever stops. Furthermore, there is a high maintenance cost for cleaning each slurry tank every few weeks.

AAC plants must produce and sell large volumes of AAC products to remain fiscally sustainable. Thus, their services must be expanded beyond local markets to be profitable, which generate another significant cost issue—product transportation. There remains a need for a cost effective method for making quality AAC and for local small energy efficient AAC production plants to successfully market AAC.

### SUMMARY

Concrete manufacturing processes are provided that can include providing a plurality of substantially dry concrete raw materials to a mixing chamber, providing water to the mixing chamber, and mixing the water and raw materials to form a concrete raw material mixture.

Concrete manufacturing processes can also include providing water, a silica source, a calcium source and an aluminum source to within a mixing chamber, with the calcium source being provided to within the chamber prior to the aluminum source.

Concrete manufacturing processes can also include providing a combustion waste, a silica source, water and an aluminum source to form a concrete raw material mixture, processing the raw material mixture to form a concrete product.

Concrete materials are provided that can include a combustion waste material, with the combustion waste material having at least 10% (wt./wt.) CaO.

### DRAWINGS

Embodiments of the disclosure are described below with reference to the following accompanying drawings.

FIG. 1 is a depiction of an AAC production scheme.

FIG. 2 is a depiction of another AAC production scheme.

FIG. 3 is a depiction of a concrete manufacturing process according to an embodiment of the disclosure.

FIG. 4 is a concrete material according to an embodiment of the disclosure.

FIG. 5 is a graphical depiction of characteristics of concrete materials according to an embodiment of the disclosure.

### DESCRIPTION

This disclosure is submitted in furtherance of the constitutional purposes of the U.S. Patent Laws “to promote the progress of science and useful arts” (Article 1, Section 8).

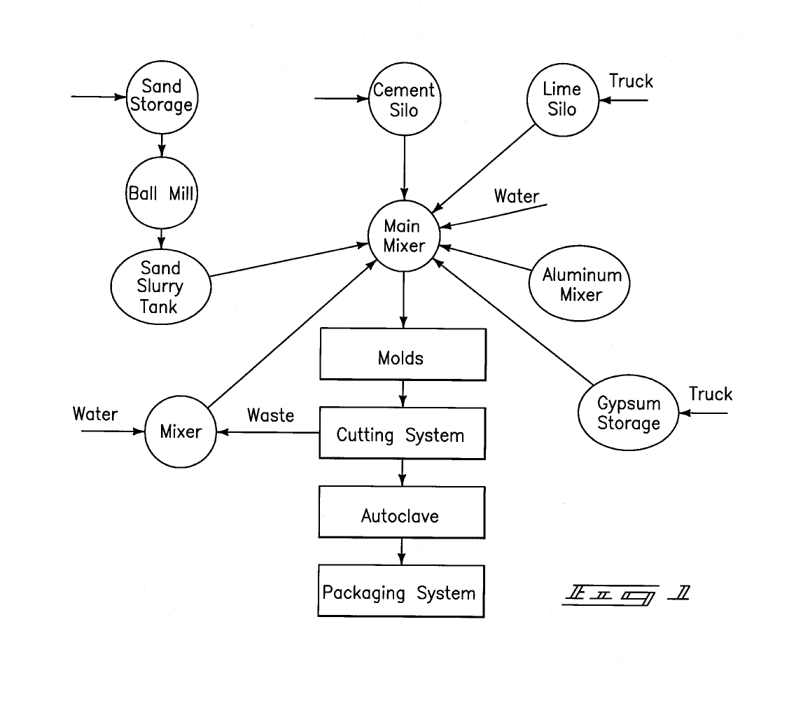

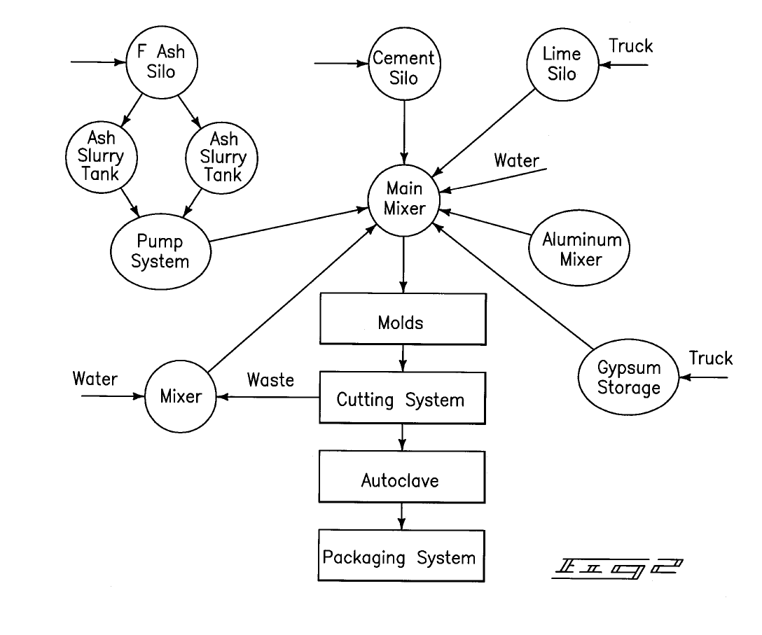

The materials and processes of the present disclosure are described with reference to FIGS. 1-5. Referring again to FIG. 1, it has been recognized that utilizing sand as a concrete raw material requires substantial energy, and further, lime requires technology to control its activity, such as addition of chemically modified quicklime. Also, the addition of gypsum can be required to slow down the reactivity of quicklime and aluminum powder to improve AAC blocks curing efficiency. Referring to FIG. 2, it has been recognized that additional sand and/or gypsum additives can also be required to improve the working parameters and quality of the final AAC products.

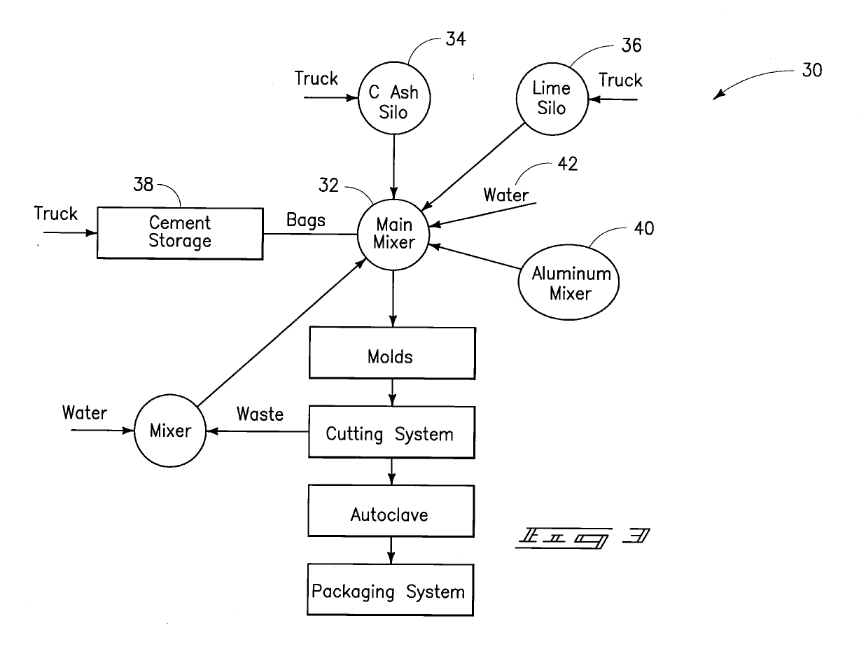

Referring to FIG. 3, a manufacturing process 30 is schematically depicted according to an embodiment to provide a plurality of substantially dry concrete-raw-materials to a mixing chamber 32. In accordance with example implementations the concrete-raw-materials can include but are not limited to calcium, silica, and aluminum sources. The calcium sources can include lime 36, cement 38 and/or a combustion waste such as Class C fly ash (C-ash) 34. The silica sources can include another combustion waste such as F-ash as well as sand and/or cement 38. The aluminum sources can include granulated raw aluminum 40, for example. These sources can be provided to mixing chamber 32 in a substantially dry form, for example less than 2 to 3% (wt./wt.) moisture.

According to an embodiment of the manufacturing process, water 42 may be provided to mixing chamber 32 to form concrete-raw-material mixture. The water may be added to chamber 32 before, after, and/or during the addition of concrete-raw-materials. The manufacturing process can include providing a combustion waste, a silica source, water, and an aluminum source to form the concrete-raw-material mixture, and process the raw-material mixture to form concrete product. The raw-material mixture can include from about 40% (wt./wt.) to about 80% (wt./wt.) combustion waste. The process can include providing cement 38 at an amount less than 15% (wt./wt.) of the raw-material mixture.

The process can provide a specific order of addition of concrete-raw-materials. According to an example implementation, the process can include providing water 42, the silica source, the calcium source, and the aluminum source to within mixing chamber 32 with the calcium source being provided to within chamber 32 prior to addition of the aluminum source. According to a specific implementation, the water is provided to the mixing chamber first, the silica source is provided to the mixing chamber after the water, the calcium source is provided to the mixing chamber after the silica source, and the aluminum source is provided to the mixing chamber after the calcium source.

In accordance with the schematic of FIG. 3, a C-ash based AAC plant is provided according to the present disclosure. Combustion waste such as the C-ash can be blown into a silo from a delivery truck and then augured directly from the silo into the main mixer as needed. This process may be performed without grinders and/or slurry tanks and their associated maintenance costs may be eliminated. The C-ash-based AAC plant of the present disclosure may be built and operated at a substantial cost saving as compared to that of a sand-based and/or a F-ash-based AAC plant.

The combustion waste utilized in the present process and incorporated into the concrete product or material can comprise at least about 10% (wt./wt.) CaO. ASTM (American Society for Testing and Materials) define fly ash by ASTM C 618, as the “finely divided residue that results from the combustion of ground or powdered coal.” This ASTM C 618 provides the chemical and physical parameters that effectively determine whether fly ash is classified as Class C fly ash or Class F fly ash.

In general, C-ash has more lime (CaO) content and lesser three major oxides (SiO₂, Al₂O₃, and Fe₂O₃) contents than the F-ash. As shown in Table 1 below, an F-ash includes SiO₂, Al₂O₃, and Fe₂O₃ contents that equal a combined total of 70% (wt./wt.) or greater, whereas a C-ash must have a minimum of 50% (wt./wt.) for the sum of the same oxides; F-ash contains a lower lime (CaO) content and a higher loss on ignition (LOI) than does the C-ash. C-ash can be generated by the combustion of either lignite or subbituminous coal, and F-ash is a result of burning bituminous coal. Powder form C-ash with relatively high calcium content is readily available from utilities burning Western coals, such as Powder River Coal.

Example constituents of Class F and C ash are shown in Tables 1 and 2 below. As is shown in these tables, Class F and C ash are substantially different.

TABLE 1
Chemical composition in % (wt./wt.) of ashes generated
from different coal ranks and the ASTM C 618 classification.
Table 1. Composition of Combustion Waste and ASTM Classification

| Coal Rank | Bituminous | Subbituminous | Lignite | ASTM C 618 Classification | |
|---|---|---|---|---|---|
| Fly Ash | (Class F) | (Class C) | (Class C) | Class F | Class C |
| Compound | % (wt./wt.) | % (wt./wt.) | % (wt./wt.) | | |
| SiO₂ | 51.5 | 35.8 | 28.9 | | |
| Al₂O₃ | 24.4 | 18.1 | 11.1 | | |
| Fe₂O₃ | 13.3 | 6.4 | 11.1 | | |
| SiO₂ + Al₂O₃ + Fe₂O₃ | 89.2 | 60.3 | 51.1 | 70.0% | 50.0% |
| | | | | (wt./wt.) min. | (wt./wt.) min. |
| CaO | 3 | 24.7 | 18.9 | | |
| MgO | 1 | 5.3 | 6 | | |
| Na₂O | 0.3 | 1.4 | 8 | | |
| K₂O | 2.6 | 0.4 | 0.9 | | |
| SO₃ | 0.7 | 2.1 | 6.83 | | |
| LOI | 1.8 | 0.2 | 0.42 | 6.0 max | 6.0 max |

Tables 2a and 2b Metal oxides, sulfur content, and loss on ignition (LOI) values of coal fly ashes, including one fluidized-bed combustion ash (All contents are expressed in weight %).

TABLE 2a

| Fly Ash Samples | SiO₂ | Al₂O₃ | Fe₂O₃ | CaO | MgO |
|---|---|---|---|---|---|
| Baldwin C-ash | 34.6 | 17.8 | 6.1 | 27.2 | 5.8 |
| Marion FBC (C-ash) | 39.2 | 14.3 | 8.6 | 16.3 | 1.1 |
| Coffeen F-ash | 48.8 | 21.4 | 6.7 | 4.4 | 1.3 |
| Vermillion C-ash | 23.9 | 16.9 | 5.6 | 24.7 | 5.2 |

TABLE 2b

| Fly Ash Samples | Na₂O | K₂O | P₂O₅ | S | LOI |
|---|---|---|---|---|---|
| Baldwin C-ash | 2.3 | 0.5 | 1.3 | 0.8 | 0.9 |
| Marion FBC(C-ash) | 0.7 | 2.0 | 0.2 | 3.3 | 9.3 |
| Coffeen F-ash | 2.0 | 2.8 | 0.2 | 0.6 | 13.0 |
| Vermillion C-ash | 1.7 | 0.6 | 1.3 | 1.7 | 15.7 |

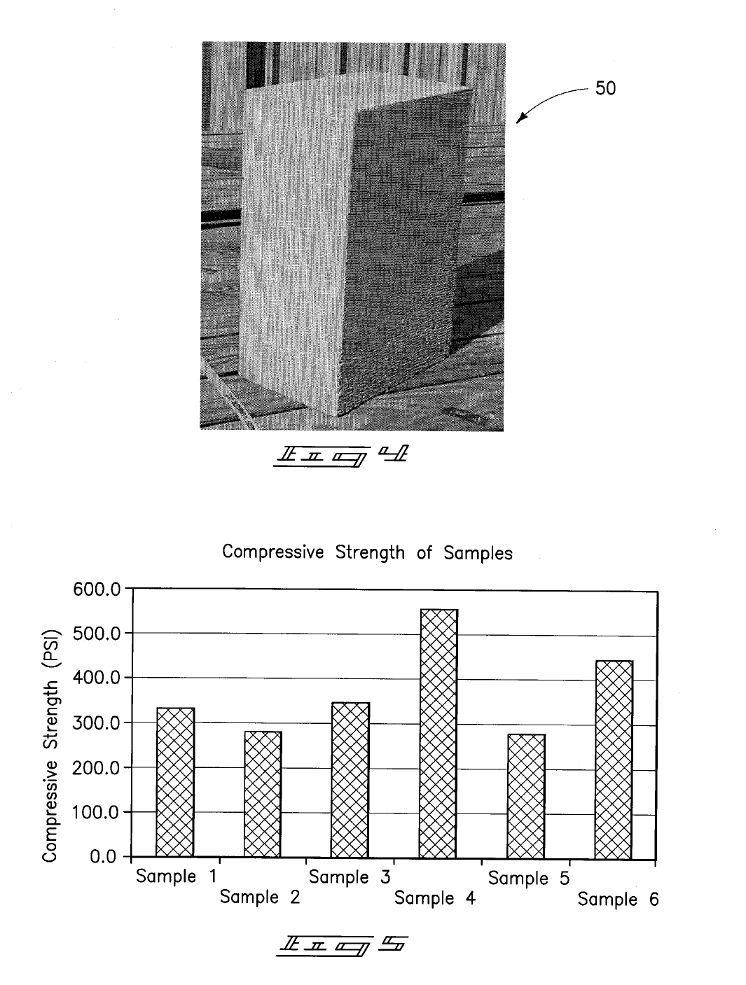

Baldwin C-ash (Loss On Ignition (LOI)=0.9 wt %) has been tested in bench-scale runs for the manufacture of AAC and pilot runs. The results of these runs are demonstrated in FIGS. 4 and 5. Marion FBC (Fluidized Bed Combustion) (C-ash) (LOI=9.3 wt %) was tested in bench-scale runs for making AAC, and the AAC block containing 56 wt % of Marion FBC(C-ash) showed compressive strength at 410 psi and density of 623.54 kg/m³ (38.85 lbs/ft³). Coffeen F-ash (LOI=13.0 wt %) was tested in bench-scale runs for making AAC, and the AAC block containing 62 wt % of Coffeen F-ash showed compressive strength at 611 psi and density of 631.41 kg/m³ (39.34 lbs/ft³). Vermillion C-ash (LOI=15.7 wt %) was tested for making AAC is in progress. In accordance with example implementations, C-ash having LOI value as high as 9.3 wt % and F-ash with LOI as high as 13 wt % can be utilized.

According to example implementations, the manufacturing process of the present disclosure can be considered to substitute a combustion waste for sand and reduce processing and operation costs significantly. The process may also provide a cost effective manufacturing method utilizing the combustion waste, such as C-ash, to produce AAC products with unique compositions.

Referring to FIG. 3, processing the raw-material-mixture to form a concrete product can include molding the mixture, separating the molded mixture into a plurality of pieces, and heating the pieces to form substantially dry concrete bricks. In accordance with an example implementation of the process, during the separating, waste materials are formed and the process further comprises providing these waste materials to the concrete-raw-material mixture.

Referring to FIGS. 4 and 5 for example, concrete material 50, as shown in the shape of a block or brick, is provided. Material 50 can be in the form of a plurality of these blocks/bricks with each individual block or brick have a density of less than 800 kg/m³. Material 50 can include a combustion waste such as the C-ash and this combustion waste may have a CaO content greater than 10% (wt./wt.). The material may contain between from about 40% (wt./wt.) and 80% (wt./wt.) combustion waste. The concrete material may also contain less than 15% (wt./wt.) cement.

In accordance with example implementations, commercial quality AAC blocks with a range of 40% (wt./wt.) to 80% (wt./wt.) by dry weight of C-ash can be produced. Embodiments of the process do not utilize additives, such as gypsum. Referring to FIG. 5, an average compressive strength of 374 psi can be obtained, from six samples, containing 73% (wt./wt.) C-ash (the compressive strengths of the AAC blocks produced with 73 wt % C-ash from scale-up production were 331, 280, 350, 559, 276, and 444 psi). This result exceeds the ASTM specification for Class AAC-2 blocks. It is believed that the compressive strength of samples may be increased by varying the mix recipe and/or optimizing autoclave parameters.

More C-ash utilized as a substitute for sand can provide for a reduction in cement and lime usage for the balance. Reducing the amount of cement utilized not only can reduce the cost for AAC production, but can also reduce the amount of harmful gaseous emissions from cement manufacturing, such as those released during Portland cement production.

Embodiments of the manufacturing process can require fewer steps than that for manufacturing sand AAC and that for manufacturing F-ash AAC. The manufacturing steps of grinding sand for the production of sand AAC, and slurry tank mixing for the production of F-ash AAC have very high associated costs. Both grinding and slurry tank mixing steps may not be required for manufacturing C-ash AAC under the disclosed process. The disclosed AAC production process can be applied to build small, inexpensive AAC production plants to serve local markets.

Grinding sand and a slurry tank mixing are two manufacturing steps with high associated costs in sand AAC and in F-ash AAC production. The current AAC plants must produce and sell large volumes of AAC products to cover their initial capital investment and annual operation costs associated with these two processes. Thus, their services must be expanded beyond local markets to be profitable, which generates another significant cost factor—product transportation. According to embodiments of the disclosure, a cost effective manufacturing method which utilizes a new raw feed substitute for sand and reduces the processing and operation costs for local energy efficient AAC production plants is provided.

Manufacturing processes are also provided that control the amount of calcium and silica input as raw materials. Sand can have a high silica content with a SiO₂ value as high as 99.9% (wt./wt). F-ash can have a low calcium content with CaO values ranging from 3% (wt./wt.) to 5% (wt./wt.) and medium silica content with SiO₂ values ranging from 45% (wt./wt.) to 50% (wt./wt.). C-ash can have CaO values ranging from 18% (wt./wt.) to 25% (wt./wt.) and SiO₂ values ranging from 26% (wt./wt.) to 35% (wt./wt.). Portland cement (Type 1) can have CaO values around 64% (wt./wt.) and SiO₂ values around 22% (wt./wt.). Lime can have CaO values as high or higher than 90% (wt./wt.).

Calcium and silica can be input using the above raw materials at specific ratios. The ratio can be expressed as a CaO/SiO₂ ratio and raw materials can be utilized to maintain this ratio between from about 0.38 and 0.73. Test runs can indicate that raw materials having C-ash greater than 50% (wt./wt.) are feasible and AAC blocks produced with 60% (wt./wt.) C-ash have compressive strength of 696.8 psi.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A concrete manufacturing process comprising:
providing a plurality of substantially dry concrete-raw-materials to a mixing chamber;
providing water to the mixing chamber; and
mixing the water and raw-materials to form a concrete-raw-material mixture.

2. The process of claim 1 wherein the concrete-raw-materials comprise at least a combustion waste.

3. The process of claim 1 wherein the water is provided to the mixing chamber prior to the concrete-raw-materials.

4. The process of claim 1 wherein the concrete-raw-materials comprise from about 2% (wt./wt.) to about 3% (wt./wt.) moisture.

5. A concrete manufacturing process comprising providing water, a silica source, a calcium source and an aluminum source to within a mixing chamber, wherein the calcium source is provided to within the chamber prior to the aluminum source.

6. The process of claim 5 wherein:
the water is provided to the mixing chamber first;
the silica source is provided to the mixing chamber after the water;
the calcium source is provided to the mixing chamber after the silica source; and
the aluminum source is provided to the mixing chamber after the calcium source.

7. The process of claim 5 wherein the calcium source comprises a combustion waste.

8. The process of claim 5 wherein the calcium source comprises C-ash.

9. A concrete manufacturing process comprising:
providing a combustion waste, a silica source, water and an aluminum source to form a concrete-raw-material mixture; and
processing the raw-material mixture to form a concrete product.

10. The process of claim 9 wherein the combustion waste comprises at least 10% (wt./wt.) CaO.

11. The process of claim 9 wherein the combustion waste comprises C-ash.

12. The process of claim 9 wherein the concrete-raw-material mixture comprises from about 40% (wt./wt.) to about 80% (wt./wt.) of the combustion waste.

13. The process of claim 9 wherein the silica source comprises cement.

14. The process of claim 9 wherein the processing the raw-material mixture to form a concrete product comprises:
molding the mixture;
separating the molded mixture into a plurality of pieces; and
heating the pieces to form substantially dry concrete bricks.

15. The process of claim 14 wherein during the separating waste materials are formed and the process further comprises providing these waste materials to the concrete-raw-material mixture.

16. A concrete material comprising a combustion waste, the combustion waste having at least 10% (wt./wt.) CaO.

17. The concrete material of claim 16 further comprising less than 15% (wt./wt.) cement.

18. The concrete material of claim 16 wherein the combustion waste is from about 40% (wt./wt.) to about 80% (wt./wt.) of the concrete material.

19. The concrete material of claim 16 having a density from about 300 to 800 kg/m³.

20. The concrete material of claim 16 defining a plurality of blocks.
